(19) United States
(12) Patent Application Publication
(10) Pub. No.: US 2005/0072344 A1
(43) Pub. Date: Apr. 7, 2005

(54) Closing wheel arm pivot assembly

(76) Inventor: Philip C. Kester, East Moline, IL (US)

Correspondence Address: THOMPSON & THOMPSON, P.A., P.O BOX 166, SCANDIA, KS, 66966, US

(21) Appl. No.: 10/948,893

(22) Filed: Sep. 22, 2004

Related U.S. Application Data
(60) Provisional application No. 60/505,712, filed on Sep. 22, 2003.

(51) Int. Cl. A01C 5/00

(52) U.S. Cl. 111/135

(57) ABSTRACT

A pivot assembly for attaching a closing wheel arm to a bearing housing of a no-till drill has a pair of sleeve bearings, a pair of seals, and a pivot bushing or pivot pin that extends through the sleeve bearings and seals. The sleeve bearings are press fit into opposite ends of a bore of the bearing housing and have grooves formed across bearing surfaces thereof for grease to flow to outer ends of the bearings. The seals are also press fit into the opposite ends of the bearing housing bore. The pivot bushing or pivot pin is installed into the sleeve bearings with an outer surface thereof providing a close-running fit with the bearing surfaces of the sleeve bearings. The close-running fit has a clearance within the range of 0.001 to 0.002 inch and can be provided by passing a reamer through the inner bore of the sleeve bearings.

### RELATED APPLICATIONS

This application claims the benefit of the Applicant's provisional patent Application No. 60/505,712 filed on Sep. 22, 2003.

### BACKGROUND OF THE INVENTION

1. Field of the Invention

The present invention relates generally to pivot assemblies for agricultural planters and grain drills. In particular, the present invention relates to improved pivot assemblies for mounting closing wheel arms to no-till grain drills, and more particularly to a closing wheel arm pivot repair kit for mounting a closing wheel arm equipped with sleeve bearings to a no-till grain drill.

2. Description of the Prior Art

In 1988, John Deere introduced its Model 750 no-till drill. The primary components of the individual row units are: (1) a single disk furrow opener; (2) a gauge wheel that carries the row unit and permits the planting depth to be adjusted; (3) a means of dropping seed through a tube and boot to be dropped into the furrow; (4) a press wheel that runs in the furrow and presses the seed into the bottom of the furrow; and (5) a heavy cast closing wheel set at an angle such that it pulls soil from the side of the furrow and pushes it into the furrow covering the seed. The closing wheel also firms the soil around the seed. All of these named components are supported by a single, large and complicated support casting.

The Model 750 drill and its successor models have been very successful. More than one million row units have been produced. They have proven to be very effective and for the most part durable. The one area that has probably been least durable has been the pivot for the closing wheel arm. The press wheel arm pivot is a similar design and has similar durability problems but to a lesser extent.

The original design for the closing wheel arm assembly 10 is shown in FIG. 1. The assembly 10 includes a heat-treated pivot pin 11 welded to the arm 12 and bearing surfaces provided by counterbores 13 in the bearing housing 14. The pivot pin 11 is made from approximately 1.000 inch cold drawn stock and is turned down to approximately 0.800 inch. The 1.000 inch diameter extends into the mating counterbore 13 approximately 0.75 inch. The smaller counterbore 13 is also approximately 0.75 inch long. This arrangement results in bearing surfaces at each end of the bearing housing 14, and a void area in the center that serves as a grease reservoir. The arm assembly 10 is held in position by a roll pin 15 and several flat washers 16.

The original design was subject to excessive wear both on the pin 11 and the bores 13 of the bearing housing 14. This looseness is magnified several times at the closing wheel 17, which is supported at the opposite end of the arm 12 from the bearing housing 14. This allows the closing wheel 17 to move laterally a significant amount reducing its ability to close the furrow. Another bad effect is that the looser the pivot is, the greater the tendency for the closing wheel 17 to bounce, which also reduces its effectiveness.

There was no practical way to repair this pivot arm assembly 10 in the original design. To do so it was necessary to replace the arm 12 along with the attached pin 11 and the bearing housing 14. The bearing housing 14 was especially expensive and time consuming to replace and clearly this was not practical.

In 1992, the design was changed to the pivot arm assembly 20 shown in FIG. 2. Sleeve bearings 21, 22 were added to the bearing housing 23 and the step was eliminated on the pivot pin 24. A grease reservoir was provided by the void between the sleeve bearings 21, 22. The sleeve bearings 21, 22 appear to have a high iron content and apparently are designed for heavy loads. Approximately 0.007-0.008 inch clearance is provided between the outer surface of the pin 24 and the inner surfaces of the sleeve bearings 21, 22. This relatively loose fit apparently conforms to recommended clearances for heavily loaded applications and cold drawn shafting materials. The grease zerk 25 was removed sometime during the 1992-1993 period.

This new design made it much easier and more economical to repair because it was not necessary to replace the bearing housing. It did not however improve the durability significantly.

In 1994, John Deere introduced a modified pivot arm assembly 30 in which the welded pivot pin was replaced with a bolt-on heat treated bushing 31 also made from 1.00 inch cold drawn steel, as shown in FIG. 3. This change made the repair parts for this pivot arm assembly 30 quite economical. However, durability was unaffected.

In 1998, John Deere introduced a further refined pivot arm assembly 40 in which features were added to make setting spring pressure and setting depth easier, as shown in FIG. 4. The bearing design was unchanged from that shown in FIG. 3. In 2002, John Deere again made some refinements but left the pivot design unchanged, except that grease zerks were added back.

Repair kits have been developed to repair and rebuild the bearing assemblies used in the closing wheel arms of the John Deere Model 750 no-till drills. One such repair kit has been produced and marketed by R.K. Products, Inc. for the closing wheel arm pivot on the original Model 750 drills since 1999. The latest version of this kit is shown together with a pivot arm assembly 50 in FIG. 5. The kit utilizes disc springs 51 to pull the pivot pin 52 through the bearing housing 53 with sufficient force that the inner surface of the arm 54 is forced to stay parallel with the end of the bearing housing 53. All lateral looseness is removed while leaving the arm 54 free to pivot. The pivot pin 52 is grooved to distribute grease from the grease reservoir within the bearing housing 53. The pivot arm assembly 50 also includes a wear clip 55 and an oil impregnated thrust washer 56 on one side of the bearing housing 53, and a load washer assembly 57 and tab washer 58 on the other side of the bearing housing 53. An adjusting stud 59 and locknut 60 are also provided. This kit is an adaptation of R.K. Products, Inc.'s gauge wheel arm pivot kit used on planters since 1994, which is described in U.S. Pat. No. 5,904,107.

This repair kit was also used on the later Model 750 drills and successor models, which are equipped with sleeve bearings as described above and shown in FIGS. 2 to 4. However, there is a need in the industry for a new and improved pivot arm repair kit that better utilizes the sleeve bearing design provided in these later drills, which is the subject of the present application.

### SUMMARY OF THE INVENTION

An object of the present invention is to provide a repair kit for a closing wheel arm pivot assembly that solves the problems and disadvantages in the prior art described above.

Another object of the present invention is to provide an improved pivot assembly that can be used for increasing the longevity and improving the performance of closing wheel arm pivots, press wheel arm pivots, and other oscillating load applications.

Another object of the present invention is to provide a repair kit for an oscillating load pivot assembly that is easy to install, that is dependable and capable of a long service life, that is economical to manufacture, and that is particularly well suited for use in repairing closing wheel arm pivot assemblies for no-till drills.

In order to accomplish these and other objects of the invention, a closing wheel arm pivot assembly is provided for attaching a closing wheel arm to a bearing housing of a no-till drill. The pivot assembly has a pair of sleeve bearings, a pair of seals, and a pivot bushing or pivot pin that extends through the sleeve bearings and seals. The sleeve bearings are press fit into opposite ends of a bore of the bearing housing and have grooves formed across bearing surfaces thereof for grease to flow to outer ends of the bearings. The seals are also press fit into the opposite ends of the bearing housing bore. The pivot bushing or pivot pin is installed into the sleeve bearings with an outer surface thereof providing a close-running fit with the bearing surfaces of the sleeve bearings. The close-running fit has a clearance within the range of 0.001 to 0.002 inch and can be provided by passing a reamer through the inner bore of the sleeve bearings. The sleeve bearings are preferably formed of oil-impregnated bronze material. A special attachment bolt with a grease zerk installed therein can be used to supply grease into the pivot assembly.

According to a broad aspect of the present invention, a pivot assembly for attaching a closing wheel arm to a bearing housing of a no-till drill is provided, comprising: a pair of sleeve bearings adapted to be press fit into opposite ends of a bore of the bearing housing, the sleeve bearings each having at least one groove formed across a bearing surface thereof for allowing grease to flow to outer ends of the bearings, the sleeve bearings having an inner diameter; a pair of seals adapted to be press fit into the opposite ends of the bore of the bearing housing; and a pivot bushing or pivot pin adapted to be installed into the sleeve bearings with an outer surface of the pivot bushing or pivot pin providing a close-running fit with the bearing surfaces of the sleeve bearings.

According to another broad aspect of the present invention, a closing wheel arm assembly for attaching a closing wheel to an agricultural seeder is provided, comprising: a bearing housing mounted on the agricultural seeder, the bearing housing having a bore extending therethrough; a closing wheel arm having a first end pivotally mounted to the bearing housing and a second end on which a closing wheel is pivotally mounted; a pair of sleeve bearings press fit into opposite ends of the bore of the bearing housing, the sleeve bearings each having at least one groove formed across a bearing surface thereof for allowing grease to flow to outer ends of the bearings; a pair of seals press fit into the opposite ends of the bore of the bearing housing and arranged to keep dirt out of and grease in the pivot assembly; and a pivot bushing or pivot pin fixed at the first end of the pivot arm and extending through the sleeve bearings, an outer surface of the pivot bushing or pivot pin providing a close-running fit with the bearing surfaces of the sleeve bearings.

According to another broad aspect of the present invention, a method of rebuilding a closing wheel arm pivot assembly of an agricultural seeder is provided, comprising the steps of: removing a closing wheel arm from the seeder and removing a pivot bushing or pivot pin from the closing wheel arm; removing old sleeve bearings from a bore of a bearing housing of the seeder; installing a pair of new grooved sleeve bearings into the bore of the bearing housing until outer ends of the respective sleeve bearings are a predetermined distance within the bore of the bearing housing; providing a new pivot bushing or pivot pin for attaching the closing wheel arm to the bearing housing; running a reamer through the sleeve bearings after the sleeve bearings are installed in the bearing housing to dimension an inner bearing surface of the sleeve bearings with a close-running fit of between 0.001 to 0.002 inch with an outer surface of the new pivot bushing or pivot pin; installing a pair of seals into respective ends of the bore of the bearing housing; and installing the new pivot bushing or pivot pin through the sleeve bearings and the seals and securing the closing wheel arm to the bearing housing.

Numerous other objects of the present invention will be apparent to those skilled in this art from the following description wherein there is shown and described two preferred embodiments of the present invention, simply by way of illustration of some of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the invention is made with reference to the accompanying drawings. In the drawings:

FIG. 1 is an exploded perspective view of a prior art closing wheel arm pivot used in an early Model 750 John Deere no-till drill.

FIG. 2 is an exploded perspective view of a prior art closing wheel arm pivot used in an update to the Model 750 John Deere no-till drill.

FIG. 3 is an exploded perspective view of a prior art closing wheel arm pivot used in another update to the Model 750 John Deere no-till drill.

FIG. 4 is an exploded perspective view of a prior art closing wheel arm pivot used in a successor model John Deere no-till drill.

FIG. 5 is an exploded perspective view of a prior art closing wheel arm pivot repair kit for the Model 750 John Deere no-till drill.

FIG. 6 is an exploded perspective view of a closing wheel arm pivot repair kit according to the present invention for use with closing wheel arms having bolted pivot bushings.

FIG. 7 is an exploded perspective view of a closing wheel arm pivot repair kit according to the present invention for use with closing wheel arms having welded pivot pins.

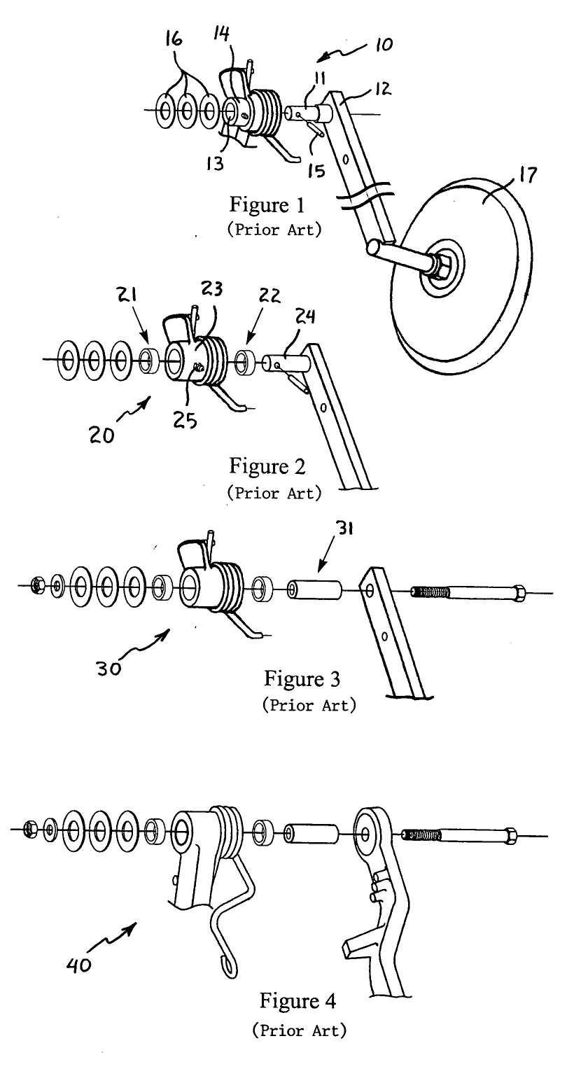

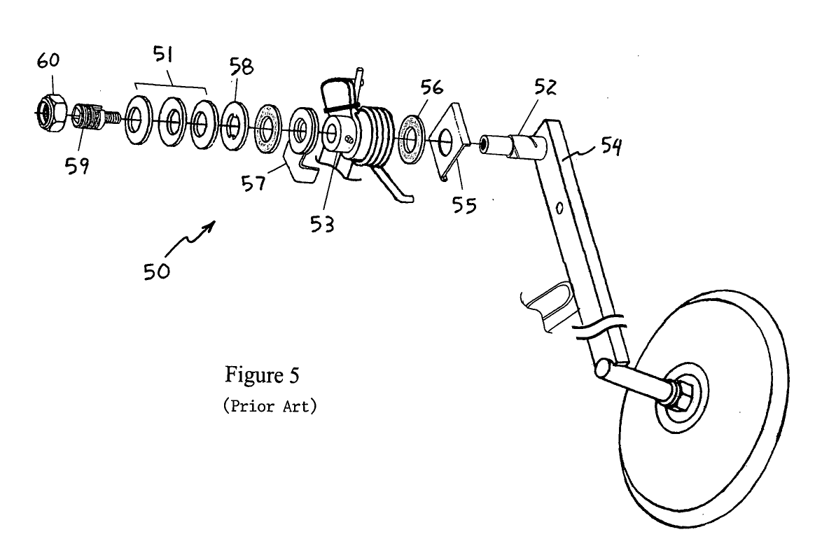

### DETAILED DESCRIPTION OF THE INVENTION

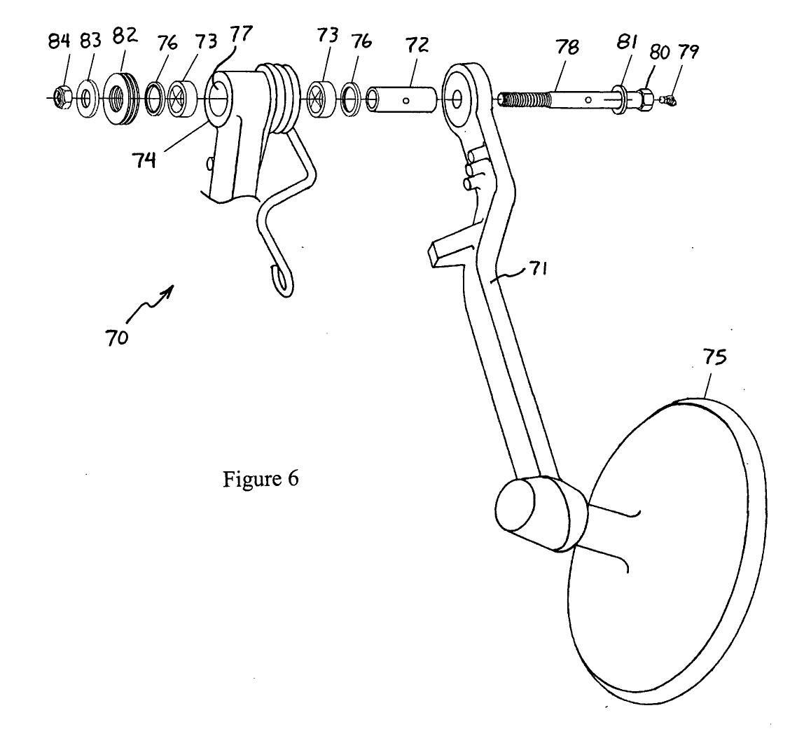

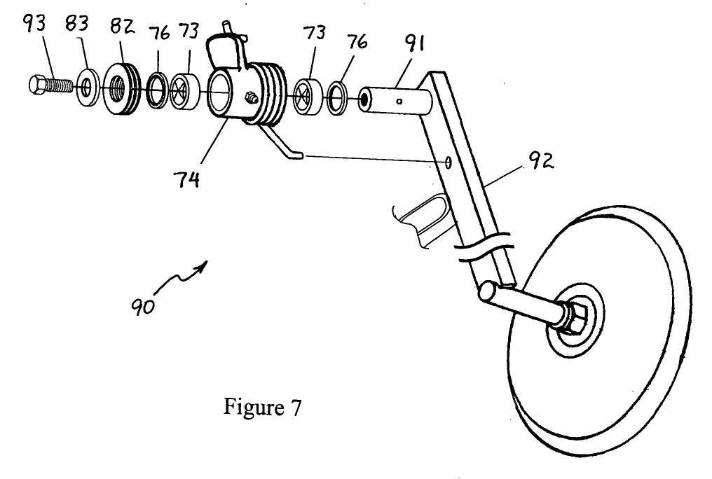

A closing wheel pivot arm assembly 70 according to preferred embodiments of the present invention will now be described with reference to FIGS. 6 and 7 of the accompanying drawings.

A closing wheel pivot arm assembly 70 according to a first embodiment of the invention is shown in FIG. 6 in conjunction with a closing wheel pivot arm 71 having a bolted pivot bushing 72. In this embodiment, the clearance between the pivot bushing 72 or pivot pin with the sleeve bearings 73 was reduced to 0.001-0.002 inch (as compared to 0.007-0.008 inch clearance in the original design). This close fit almost always requires the sleeve bearings 73 to be reamed after they are installed in the bearing housing 74. This is unusual but quite manageable for farmer installed repairs.

The close fit between the outer surface of the pivot bushing 72 and the inner surface of the sleeve bearings 73 reduces impact loading and thereby reduces wear. The close fit also improves the performance of the drill by forcing the closing wheel 75 to track properly and by reducing the bounce of the closing wheel 75 significantly.

The close fit also facilitates the use of seals 76 on each side of the bearing housing 74 because flexure of the seals 76 is minimized and durability of the seals is improved. The seals 76 greatly reduce the amount of dirt entering the bore 77 of the bearing housing 74 and also retain grease within the bore 77. Because of the close fit, it was necessary to groove the sleeve bearings 73 to allow grease to reach the seals 76. The sleeve bearings 73 are made from oil-impregnated bronze. This is a material that is not normally recommended for heavily loaded applications. However, the Applicant has discovered that such material, when used in conjunction with a close fit, provides a significant improvement over non-lubricated sleeve bearings in this particular application.

Lubrication is typically a problem in oscillating load applications. The grease works out of the loaded areas and the oscillating motion does not allow grease to be carried back into those areas. The oil within the porous bronze material of the sleeve bearings 73 assures that there will almost always be some lubricant available.

For drills that have no grease zerks a special bolt 78 can be provided. The bolt 78 is center drilled and cross drilled and a grease zerk 79 is installed in the head 80 of the bolt 78. The pivot bushing 72 is cross drilled to allow the grease to reach the inner surfaces of the sleeve bearings 73 and the seals 76. This arrangement makes it unnecessary to install a grease zerk in the bearing housing 74. A similar repair kit using many of the same parts as above can be provided for the press wheel arm pivot of an agricultural seeder implement.

The closing wheel pivot arm assembly 70 of the present invention can be packaged as a repair kit and readily incorporated into the prior art pivot arm assemblies described above. The closing wheel pivot arm assembly 70 according to the present invention has at least three unique features that provide significant improvements over the prior art. First, the closer than normally recommended fit between the pivot bushing 72 or pin and the sleeve bearings 73 reduces impact loading, thereby reducing wear. The conventional closing wheel pivot was made with a clearance of about 0.007-0.008 inch, which was within the recommended clearance range of 0.0045-0.010 inch established for a “loose-running fit” for a one inch diameter pin according to ANSI B4.1-1967 (R1979). The Applicant has discovered that providing a “close-running fit” with a clearance range of 0.001-0.002 inch between the pivot bushing 72 or pin and the sleeve bearings 73 provides a surprising improvement over such prior art. The phrase “close-running fit” in the present application is given the same meaning as in ANSI B4.1-1967 (R1979).

Second, the closer fit makes the use of seals 76 more feasible because of reduced seal flexure, which results in better seal performance. Third, the oil impregnated bronze sleeve bearings 73 assure that some lubricant will almost always be available in the loaded bearing areas.

The construction of the closing wheel pivot arm assembly 70 and repair kit for John Deere no-till drills with sleeve bearings and bolted pivot bushings according to the present invention is described above. The installation procedure for installing such repair kits to an existing pivot arm assembly will now be described with reference to FIG. 6.

The first step in installing the kit is to remove the closing wheel arm 71 from the seeder and the old pivot bushing from the closing wheel arm 71. The old sleeve bearings are then removed from the bore of the bearing housing 74, and the bore 77 of the bearing housing 74 is cleaned to remove any residual dirt and grease.

The next step is to install the new grooved sleeve bearings 73 provided in the repair kit. The sleeve bearings 73 are pressed into the bore of the bearing housing 74 until the outer ends of the respective sleeve bearings 73 are positioned a predetermined distance (e.g., approximately ¼ inch) from the respective end of the bearing housing 74. A pilot bushing can be used to facilitate installation of the sleeve bearings 73 and seals 76. If a grease zerk which was previously installed in the bearing housing is to be used, it may be necessary to drill a small hole (approximately ⅛ inch) through the sleeve bearing 73 in line with the tapped hole in the bearing housing 74.

Once the new sleeve bearings 73 are installed, a reamer is run through the inner bore of the sleeve bearings 73 to provide the close-running fit according to the present invention. The reamer functions to dimension the inner bearing surface of the sleeve bearings 73 with a close-running fit of between 0.001 to 0.002 inch with the outer surface of the new pivot bushing. The seals 76 are then installed into each respective side of the bearing housing 74 with their lips facing outward. The seals 76 are positioned adjacent to the respective outer ends of the new sleeve bearings 73 and are pressed into the bearing housing 74 until they are flush with the ends of the bearing housing 74.

Once the seals 76 are installed, grease is applied to the lips of the seals 76 and to one end of the pivot bushing 72. The pivot bushing 72 is then installed into the bearing housing 74 being careful not to damage the seals 76. As described above, a close-running fit of approximately 0.001-0.002 inch is provided between the outer surface of the pivot bushing 72 and the inner surface of the sleeve bearings 73 to reduce impact loading and wear, and to facilitate the use of seals 76.

A washer 81 (shown on the right side) is then installed onto the bolt 78. The bolt 78 is then installed through the arm 71 and the pivot bushing 72. Heat-treated adjusting washers 82 (shown on the left side) are installed as required to minimize axial movement. Another washer 83 and a regular ⅝″ threaded hex nut are then installed and the nut is tightened. When axial movement is minimized, the regular nut is then replaced with a locknut 84 to keep the closing wheel arm 71 secured to the bearing housing 74.

The grease zerk 79 is then installed into a threaded bore in the head 80 of the bolt 78. The grease zerk 79 can be redirected to improve accessability by loosening the nut 84 and rotating the bolt 78 as necessary. The pivot arm assembly 70 is then greased by injecting grease through the zerk 79 in a known manner. The pivot arm assembly 70 should then be regreased at regular intervals (e.g., 50 hours of operation) to ensure longevity.

A pivot arm assembly 90 according to a second embodiment of the Applicants's invention is shown in FIG. 7. This pivot arm assembly 90 is similar to that shown in FIG. 6, except that the pivot pin 91 is welded to the closing wheel arm 92 instead of using a removable bolt and pivot bushing. Thus, a repair kit for this pivot arm assembly 90 can be used with the conventional closing wheel arm pivot assembly 20 having a welded pivot pin as shown in FIG. 2. The various components having the same structure and function as those in FIG. 6 are given the same reference numerals in FIG. 7.

Installation of the pivot arm repair kit for the pivot arm assembly 90 shown in FIG. 7 is similar to the above-described installation of the repair kit for the pivot arm assembly 70 shown in FIG. 6. However, the old pivot pin is removed from the closing wheel arm 92 by grinding the welded end of the pivot pin flush and then pressing the old pivot pin through the closing wheel arm 92. A new pivot pin 91 is installed into the closing wheel arm 92 until it protrudes from the opposite side of the arm approximately ¼ inch. The fit between the new pivot pin 91 and the hole in the closing wheel arm 92 is tight enough to assure proper alignment. The pivot pin 91 is then welded to the closing wheel arm 92. The other difference is that the final assembly of the pivot arm assembly after the pivot pin 91 is inserted through the sleeve bearings 73 is made by threading a bolt 93 into the end of the welded pivot pin 91. The bolt 93 serves to keep the closing wheel arm 92 secured to the bearing housing 74.

While the invention has been specifically described in connection with specific embodiments thereof, it is to be understood that this is by way of illustration and not of limitation, and the scope of the appended claims should be construed as broadly as the prior art will permit.

1. A pivot assembly for attaching a closing wheel arm to a bearing housing of a no-till drill, comprising:
a pair of sleeve bearings adapted to be press fit into opposite ends of a bore of the bearing housing, said sleeve bearings each having at least one groove formed across a bearing surface thereof for allowing grease to flow to outer ends of the bearings, said sleeve bearings having an inner diameter;
a pair of seals adapted to be press fit into the opposite ends of the bore of the bearing housing; and
a pivot bushing or pivot pin adapted to be installed into the sleeve bearings with an outer surface of the pivot bushing or pivot pin providing a close-running fit with the bearing surfaces of the sleeve bearings.

2. The pivot assembly according to claim 1, wherein said pivot bushing or pivot pin has an outer diameter, and a clearance between the inner diameter of the sleeve bearings and the outer diameter of the pivot bushing or pivot pin being within a range of 0.001-0.002 inch.

3. The pivot assembly according to claim 2, wherein said sleeve bearings comprise an oil-impregnated bronze material.

4. The pivot assembly according to claim 3, wherein said seals are arranged to keep dirt out of the pivot assembly and grease in.

5. The pivot assembly according to claim 1, wherein said sleeve bearings comprise an oil-impregnated bronze material.

6. The pivot assembly according to claim 1, wherein said seals are arranged to keep dirt out of the pivot assembly and grease in.

7. The pivot assembly according to claim 1, further comprising a threaded bolt for supporting the pivot bushing, said threaded bolt having an internal bore, a cross bore, and an opening for mounting a grease zerk for lubricating the pivot assembly.

8. A closing wheel arm assembly for attaching a closing wheel to an agricultural seeder, comprising:
a bearing housing mounted on the agricultural seeder, said bearing housing having a bore extending therethrough;
a closing wheel arm having a first end pivotally mounted to said bearing housing and a second end on which a closing wheel is pivotally mounted;
a pair of sleeve bearings press fit into opposite ends of said bore of the bearing housing, said sleeve bearings each having at least one groove formed across a bearing surface thereof for allowing grease to flow to outer ends of the bearings;
a pair of seals press fit into the opposite ends of the bore of the bearing housing and arranged to keep dirt out of and grease in the pivot assembly; and
a pivot bushing or pivot pin fixed at the first end of the pivot arm and extending through the sleeve bearings, an outer surface of the pivot bushing or pivot pin providing a close-running fit with the bearing surfaces of the sleeve bearings.

9. The closing wheel arm assembly according to claim 8, wherein said pivot bushing or pivot pin has an outer diameter, and a clearance between the inner diameter of the sleeve bearings and the outer diameter of the pivot bushing or pivot pin being within a range of 0.001-0.002 inch.

10. The closing wheel arm assembly according to claim 9, wherein said sleeve bearings comprise an oil-impregnated bronze material.

11. The closing wheel arm assembly according to claim 8, wherein said sleeve bearings comprise an oil-impregnated bronze material.

12. The closing wheel arm assembly according to claim 8, wherein said pivot bushing or pivot pin comprises a pivot pin which is permanently fixed to the first end of the closing wheel arm.

13. The closing wheel arm assembly according to claim 8, wherein said pivot bushing or pivot pin comprises a pivot bushing which is removably attached to the first end of the closing wheel arm by a threaded machine bolt passing through a center bore of said pivot bushing.

14. The closing wheel arm assembly according to claim 13, wherein said threaded machine bolt has an internal longitudinal bore, a cross bore, and an opening having a grease zerk mounted therein for lubricating the pivot assembly.

15. A method of rebuilding a closing wheel arm pivot assembly of an agricultural seeder, comprising the steps of:
removing a closing wheel arm from the seeder and removing a pivot bushing or pivot pin from the closing wheel arm;
removing old sleeve bearings from a bore of a bearing housing of the seeder;
installing a pair of new grooved sleeve bearings into the bore of the bearing housing until outer ends of the respective sleeve bearings are a predetermined distance within the bore of the bearing housing;
providing a new pivot bushing or pivot pin for attaching the closing wheel arm to the bearing housing;
running a reamer through the sleeve bearings after the sleeve bearings are installed in the bearing housing to dimension an inner bearing surface of the sleeve bearings with a close-running fit of between 0.001 to 0.002 inch with an outer surface of the new pivot bushing or pivot pin;
installing a pair of seals into respective ends of the bore of the bearing housing; and
installing the new pivot bushing or pivot pin through the sleeve bearings and the seals and securing the closing wheel arm to the bearing housing.

16. The method according to claim 15, wherein said new sleeve bearings are made of oil-impregnated bronze material.

17. The method according to claim 15, wherein said step of removing a pivot bushing or pivot pin from the closing wheel arm comprises removing a pivot bushing from the closing wheel arm by removing a threaded machine bolt from within an inner bore of the pivot bushing; and
wherein said step of installing the new pivot bushing or pivot pin comprises inserting a new pivot bushing through the sleeve bearings and the seals and securing the closing wheel arm to the bearing housing by inserting a threaded machine bolt through an inner bore of the new pivot bushing and an opening in the closing wheel arm.

18. The method according to claim 17, wherein said threaded machine bolt has an internal bore, a cross bore, and an opening for mounting a grease zerk for lubricating the pivot assembly.

19. The method according to claim 15, wherein said step of removing a pivot bushing or pivot pin from the closing wheel arm comprises removing a pivot pin from the closing wheel arm by grinding a welded end of the pivot pin flush with the closing wheel arm and then forcing the pin out of the arm; and
wherein said step of installing the new pivot bushing or pivot pin comprises welding a new pivot pin to the closing wheel arm before inserting the new pivot pin through the sleeve bearings and the seals.
